(19) United States
(12) Patent Application Publication
(10) Pub. No.: US 2016/0039239 A1
(43) Pub. Date: Feb. 11, 2016

(54) LAMINATING A BOOK COVER

(71) Applicant: VIVID LAMINATING TECHNOLOGIES LIMITED, Coalville, Leicestershire (GB)

(72) Inventors: Gavin Ward, Leicestershire (GB); Bruce Cozens, Yoxall, Staffordshire (GB)

(21) Appl. No.: 14/439,299

(22) PCT Filed: Apr. 25, 2014
(86) PCT No.: PCT/GB2014/000156

§ 371 Date: Apr. 29, 2015

(30) Foreign Application Priority Data
Apr. 26, 2013 (GB) 1307594.0

(51) Int. Cl. B42C 11/04; B32B 38/10; B32B 37/22

(52) U.S. Cl. CPC B42C 11/04; B32B 37/226; B32B 38/10

(57) ABSTRACT

A central strip of the inside surface of the cover of a book, ledger or the like is left exposed from laminating material applied elsewhere to the surface so as to bond better to the stack of pages or to a glue strip binding the left-hand edges of the pages of the book. In a preferred embodiment a central strip is cut from a sheet of laminating material as it is drawn from a roll by a pair of cutters the spacing apart of which is adjustable to be not less than the height of the stack or glue strip.

### CROSS-REFERENCE TO RELATED APPLICATIONS

This application is a 371 National Phase of PCT/GB2014/000156 filed on Apr. 25, 2014, which claims priority to Great Britain Patent Application No. GB 1307594.0 filed on Apr. 26, 2013, the entire contents of both of which are incorporated by reference herein.

### FIELD

This invention relates to an improved technique for laminating the cover of a book, ledger or the like.

### BACKGROUND

It is a common practice to laminate the external surface of the cover of a book to protect it against dirt, moisture and damage. However the application of a layer of plastics material to only one side of a cover, especially if heat is used, tends to cause it to curl. To prevent this it is desirable to laminate both sides of a cover—the inside surface as well as the outside surface. The problem that then arises is that a glue used to bind the pages to the cover will not adhere well to a laminated surface.

A principal object of the present invention is to overcome this problem.

### SUMMARY

In accordance with one aspect of the present invention there is provided a method of laminating the cover of a book, ledger or the like which comprises applying laminating material to the inside surface of the book so as to leave the material of the cover exposed from the laminating material in a central strip to which glue will be applied to bind the pages to the cover.

A central strip may be removed from a sheet of laminating material before it is applied to the inside surface of the cover so that glue can be applied directly to the cover material and not to a laminated surface.

Preferably the central strip is removed by a pair of spaced apart cutters as the sheet of laminating material is being drawn from a roll. The spacing apart of the cutters is preferably adjusted to be not less than the height of the stack of pages or of a glue strip applied to the left-hand edges of the pages of the book, ledger or the like. In accordance with another aspect of the present invention there is provided apparatus for carrying out the method of the preceding three paragraphs, the apparatus comprising a pair of cutters adjustable along a guide parallel with a roll from which the sheet is being drawn.

### BRIEF DESCRIPTION OF THE DRAWINGS

A preferred embodiment of the invention will now be described by way of non-limitative example with reference to the accompanying drawings, in which:

FIG. 1 illustrates a roll from which a sheet of laminating material is being drawn to be applied to the inside surface of a book cover, and

FIG. 2 illustrates the inside surface of a book cover to which the laminating sheet of

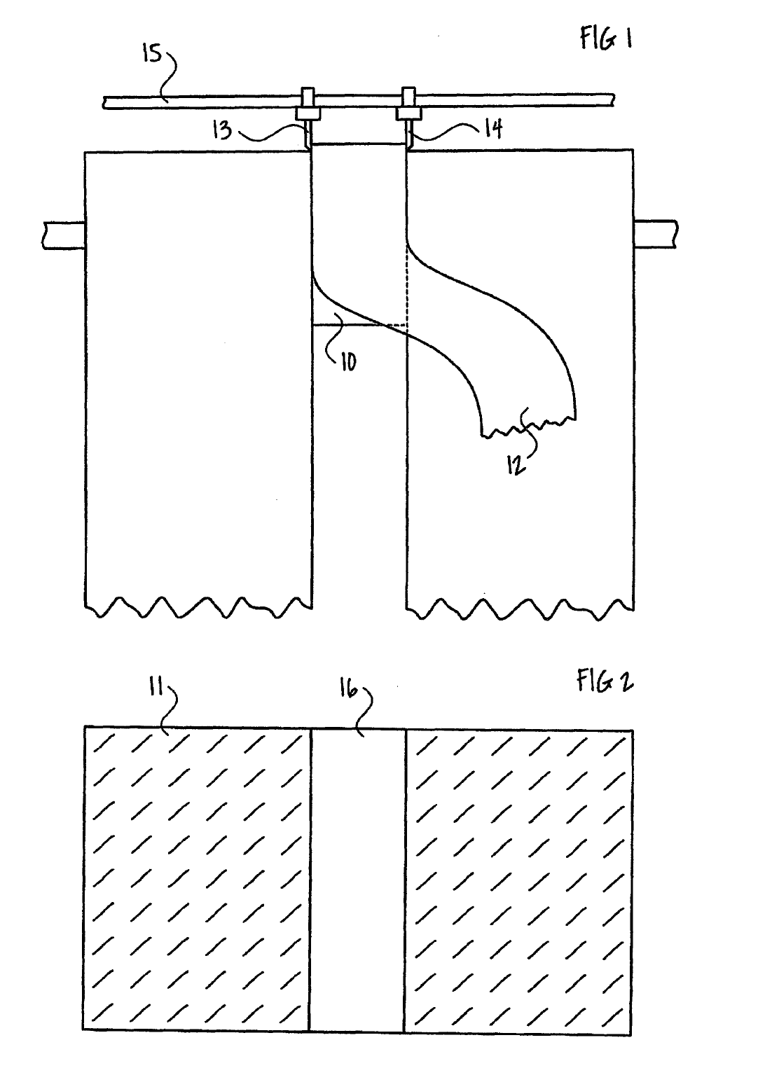

FIG. 1 has been applied.

### DETAILED DESCRIPTION

As shown in the drawings, a sheet of laminating material is being drawn from a roll 10 to be applied to the inside surface 11 of a book cover. Laminating material is also applied to the whole of the external surface of the cover (not visible in FIG. 2). As is known per se the left-hand edges of the pages of the book (not shown) are glued together. The glue extends throughout the height of the stack of pages and slightly overlaps the outermost pages of the stack.

In accordance with the present invention a central strip 12 is cut from the laminating material as it is drawn from the roll 10. The cutting is effected by two cutters 13 and 14 which are adjustable along a rod or guide 15 parallel with the roll 10. The spacing apart of the cutters 13 and 14 is adjusted to be not less than the height of the stack of pages or the width of a glue strip applied to them. This mean that a central strip 16 of the inside surface of the book cover is exposed from the laminating material. The card or similar material of the cover will adhere better to the stack of pages or glue strip than would a laminated surface when glue is applied to the stack or to the exterior of the glue strip and it is positioned centrally in the strip 16.

1. A method of laminating the cover of a book, ledger or the like, the method comprising applying laminating material to an inside surface of the book so as to leave the material of the cover exposed from the laminating material in a central strip to which glue will be applied to bind the pages to the cover.

2. A method as claimed in claim 1, wherein a central strip is removed from a sheet of laminating material before it is applied to the inside surface of the cover so that glue can be applied directly to the cover material and not to a laminated surface.

3. A method as claimed in claim 2, wherein the central strip is removed by a pair of spaced apart cutters as the sheet of laminating material is being drawn from a roll.

4. A method as claimed in claim 3, wherein the spacing apart of the cutters is adjusted to be not less than the height of the stack of pages or a glue strip applied to the left-hand edges of the pages of the book, ledger or the like.

5. (canceled)

6. Apparatus for laminating the cover of a book, ledger or the like with laminating material drawn from a roll, the apparatus comprising a pair of cutters adjustable along a guide parallel to an axis of the roll of laminating material, the cutters being configured to remove a central strip from a sheet of the laminating material before it is applied to an inside surface of the cover so as to leave a central strip of the cover exposed.

7. Apparatus according to claim 6, wherein the laminating material is a plastics material.
